(19) United States
(12) Patent Application Publication
(10) Pub. No.: US 2009/0081905 A1
(43) Pub. Date: Mar. 26, 2009

(54) Electrical connector

(75) Inventor: De-Jin Chen, ShenZhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/284,378

(22) Filed: Sep. 22, 2008

(30) Foreign Application Priority Data
Sep. 22, 2007 (CN) 200720044136.8

(51) Int. Cl. H01R 24/00

(52) U.S. Cl. 439/660

(57) ABSTRACT

An electrical connector comprises an insulative housing and a plurality of terminals received in the insulative housing. Each terminal comprises a mounting portion, an engaging portion extending upwardly from the mounting portion and at least a tail portion extending downwardly from the mounting portion. The engaging portion defines a main plate, an extending portion extending upwardly from the main plate and a resilient contacting portion extending slantways and upwardly from the main plate.

### BACKGROUND OF THE INVENTION

1. Field of the Invention

The present invention relates to an electrical connector, and particularly to an electrical connector with improved terminals.

2. Description of the Related Art

Usually, these electrical connectors are mounted on a print circuit board or terminated with cable. Please referring to U.S. Pat. No. 5,131,872, Consoli discloses an electrical connector 1 adapted for mounting on a print circuit board, comprising an insulative housing 16 and a plurality of terminals 32 received in the insulative housing 16. The insulative housing 16 is elongated and comprises a plurality of receiving slots 20 for receiving the terminals 32. Each terminal 32 is stamped from a metal sheet, and comprises tail portion 40, a resilient portion 36 extending upwardly from the tail portion 40, an U-shaped portion 42 extending upwardly from the resilient portion 36 and a resilient contacting portion 50 extending upwardly from the U-shaped portion 42. The resilient contacting portion 50 is about of U-shape, and extends rearwardly and upwardly from the U-shaped portion 42 and then projects slantwise and downwardly. The tail portions 40 of the terminals 32 pass through the plurality of apertures 14 of the print circuit board 12, the U-shaped portions 42 and the contacting portions 50 are received in the receiving slots 20 of the insulative housing 16. However, this resilient contacting portion 50 extends along a direction same to the inserting direction of the complementary connector. The resilient intensity of the contacting portion will be weakened by several insertions. Accordingly, a reliable electrical connection between two connectors is affected. In addition, the structure of this contacting portion is so complicated to be mass produced and hard to reduce the cost.

Please referring to CN 2466796Y, Ho discloses a terminal 2 with a resilient contacting portion 13 immediately punched from a metal sheet, and this type design facilitates saving cost. However, this resilient contacting portion 13 extends along a direction also same to the inserting direction of the complementary connector. The resilient intensity of the contacting portion will be weakened by several insertions.

Hence, an improved electrical connector is desired to overcome the disadvantages of the prior art.

### BRIEF SUMMARY OF THE INVENTION

Therefore, a main object of the present invention is to provide an electrical connector with improved terminals.

To fulfill the above-mentioned object, an electrical connector comprises an insulative housing and a plurality of terminals received in the insulative housing. Each terminal comprises a mounting portion, an engaging portion extending upwardly from the mounting portion and at least a tail portion extending downwardly from the mounting portion. The engaging portion defines a main plate, an extending portion extending upwardly from the main plate and a resilient contacting portion extending slantways and upwardly from the main plate.

Other objects, advantages and novel features of the invention will become more apparent from the following detailed description when taken in conjunction with the accompanying drawings.

### BRIEF DESCRIPTION OF THE DRAWINGS

The foregoing summary, as well as the following detailed description of the embodiments of the present invention, will be better understood when read in conjunction with the appended drawings. For the purpose of illustrating the invention, there are shown in the drawings embodiments which are presently preferred. As should be understood, however, the invention is not limited to the precise arrangements and instrumentalities shown. In the drawings:

FIG. 1 is an assembled, perspective view of an electrical connector according to the present invention;

FIG. 2 is an exploded, perspective view of an electrical connector according to the present invention;

FIG. 3 is a view of an insulative of the electrical connector according to the present invention;

FIG. 4 is a view similar to FIG. 3, but viewed from another aspect; and

FIG. 5 is a sectional crossed view of FIG. 1.

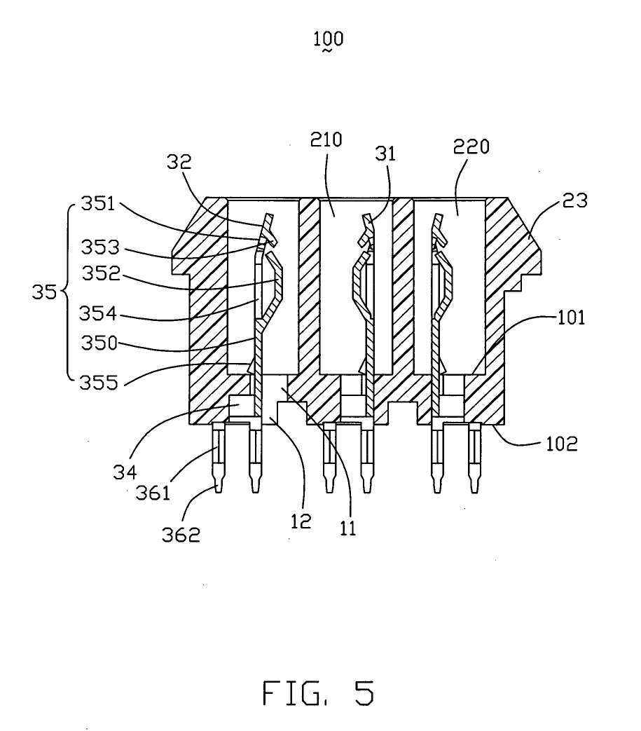

### DETAILED DESCRIPTION OF THE PREFERRED EMBODIMENT

Reference will now be made in detail to the preferred embodiment of the present invention.

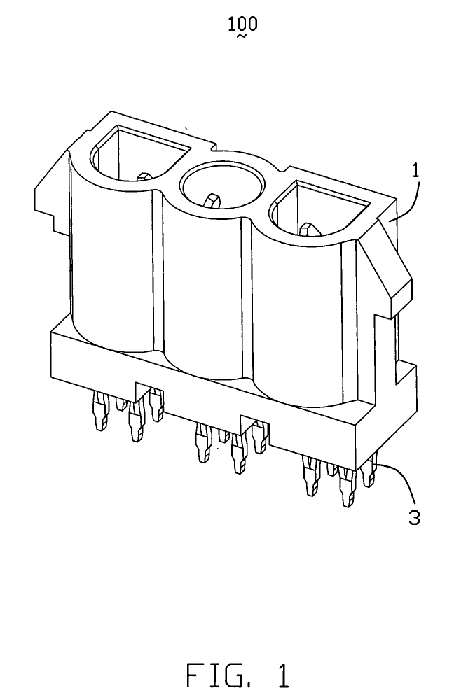

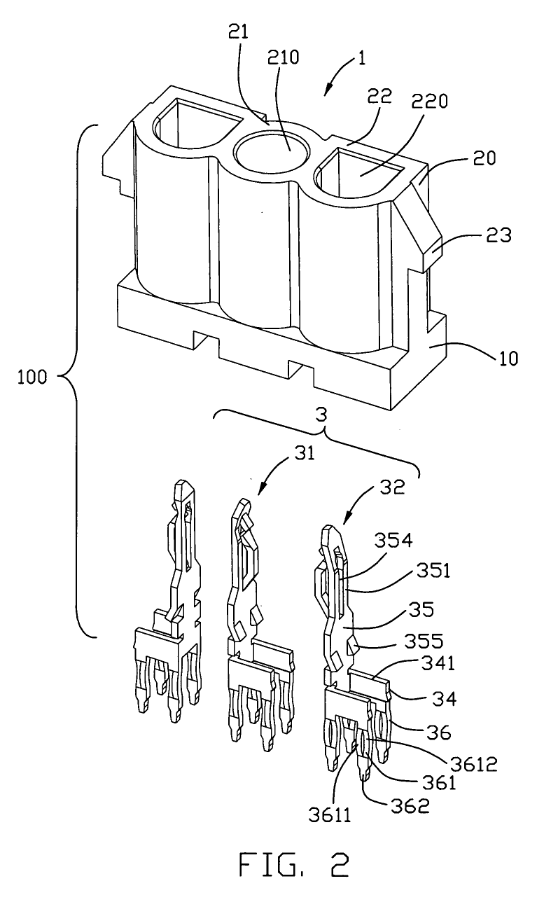

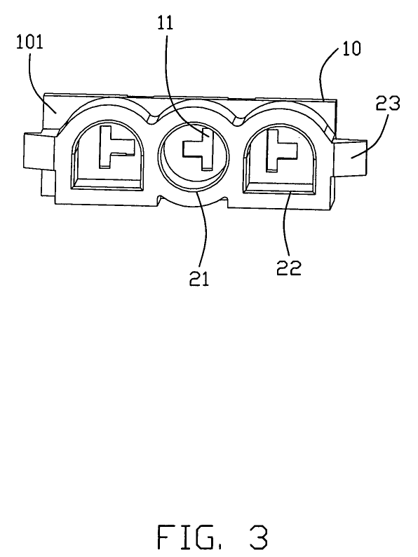

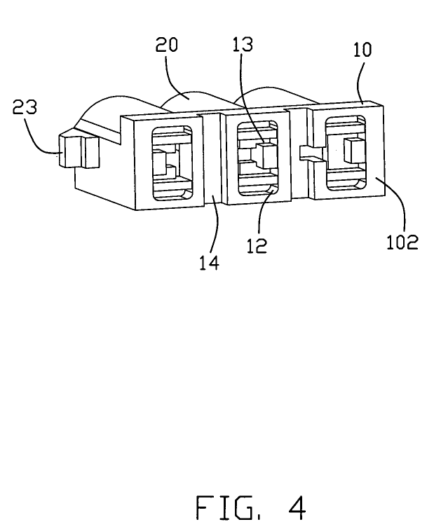

Referring to FIGS. 1-4, an electrical connector 100 according to the present invention is adapted for electrically connecting a complementary connector (not shown) and a print circuit board (not shown). The electrical connector 100 comprises an insulative housing 1 and a plurality of terminals 3 received in the insulative housing 1.

The insulative housing 1 comprises an elongated base 10 and a mating portion extending upwardly from the base 10. The base 10 defines an upper face 101 and a mounting face 102 opposite to the upper face 101. In the preferred embodiment, the upper face 101 is as the upper direction, and the mounting face 102 is as the lower direction.

The base 10 defines a plurality of recesses 12 concaved upwardly from the mounting face 102, a plurality of cutouts 14 flushed transversely adjacent to the mounting face 102 and spaced alternatively with the recesses 12 and a plurality of T-shaped slots 11 extending through the base 10 and communicating with the recesses 12. Each recess 12 defines an U-shaped retaining groove 13.

The mating portion 20 is elongated shape, and comprises a first receiving port 21 and a pair of second receiving ports 22 symmetrically located at two sides of the first receiving port 21. The first receiving port 21 defines a first receiving channel 210 communicating with the T-shaped slot 11. Each second receiving port 22 defines a second receiving slot 220 communicating with the T-shaped slot 11. To strengthen the intensity of the mating portion 20 and prevent from miss-mating, the first receiving port 21 is of columnar shape with a columnar first receiving channel 210, and the second receiving port 22 is of D-shaped structure with a D-shaped second receiving channel 220. The mating portion 20 comprises a pair of latching means 23 at two sides thereof. In the preferred embodiment, the latch means 23 is integrally form with the insulative housing 1.

The terminals 3 are stamped from a metal sheet and comprise a first terminal 31 received in the first receiving port 21 and a pair of second terminals 32 received in the second receiving port 22. The first and second terminals 31, 32 are of substantial same shape, and each comprises an U-shaped mounting portion 34, a engaging portion 35 extending upwardly from the mounting portion 34 and a plurality of tail portions extending downwardly form the mounting portion 34. The mounting portion 34 comprises a pair of arms 341 extending horizontally and being parallel with each other. The engaging portion 35 is of plate shape, and comprises main plate 350, an extending portion 351 extending upwardly from the main plate 350, a arc-shaped resilient contacting portion 352 extending slantways and upwardly from the main plate 350, a transitional portion 353 extending downwardly from the extending portion 351, an opening 354 corresponding to the resilient contacting portion 352 and the transitional portion 353 and a pair of retaining portions 355 punched downwardly from the two sides of main plate 350. The retaining portions 355 and the arms 341 are at the same side relative to the main plate 350. The transitional portion 353 is immediately located above the resilient contacting portion 352 to guide a complementary connector (not shown) and protect the resilient contacting portion 352 from being destroyed by an unexpected collision. The plurality of tail portions 36 are symmetrically located on the arms 341. Each tail portion 36 comprises a locking portion 361 and guiding portion 362 extending downwardly from the locking portion 361. The locking portions 361 comprises a first protrusion 3611 and a second protrusion 3612 punched away from each other, and the maximum thickness of the locking portion 361 is not larger than summed thickness of the first protrusion 3611 and the second protrusion 3612. It means that the first protrusion 3611 and the second protrusion 3612 do not destroy the integrity of the locking portion 361. By means of this design, the locking portion 361 is capable of securely locking with the print circuit board (not shown). The difference between the first terminal 31 and the second terminals 32 is that the resilient contacting portion 351 of the first terminal 31 and the arms 341 of the first terminal 31 are at the same side relative to the engaging portion 35, and the second resilient contacting portion 351 of the second terminal 32 and the arms 341 of the second terminal 32 are at two sides of the engaging portion 35. This design is to cooperate with the first receiving port 21 and the pair of second receiving ports 22.

In assembly, the plurality of terminal 3 are assembled into the insulative housing 1 from the mounting face 103 to the recesses 12 with the engaging portions 35 passing through the recesses 12 and T-shaped slots 11 and respectively entering into the first receiving channel 210 and the second receiving channels 220. Keeping moving the terminals 3 until the retaining portions 355 slip away the T-shaped slots 11 and resist against the upper face 101 of the base 10 for preventing the terminals 3 from moving downwardly. Under this situation, the U-shaped mounting portions 34 is positioned in the U-shaped slots 13 and resist against within the recesses 12 for preventing the terminals 3 from moving upwardly. The tail portions 36 extend beyond the recesses 12 and electrically connect with the print circuit board (not shown).

The resilient contacting portion 352 of the terminal 3 of the electrical connector 100 according to the present invention extends upwardly from the engaging portion 35. It facilitates keeping the resilient intensity of the resilient contacting portion 352 due to the extending direction opposite to the inserting direction of a complementary. In addition, the transitional portion 353 is capable of guiding insertion of a complementary connector and protecting the resilient contacting portion 352 from being destroyed by an unexpected collision.

It is to be understood, however, that even though numerous, characteristics and advantages of the present invention have been set fourth in the foregoing description, together with details of the structure and function of the invention, the disclosed is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector, comprising:
an insulative housing;
a plurality of terminals received in the insulative housing, each said terminal comprising a mounting portion, an engaging portion extending upwardly from the mounting portion and at least a tail portion extending downwardly from the mounting portion, said engaging portion defining a main plate, an extending portion extending upwardly from the main plate and a resilient contacting portion extending slantways and upwardly from the main plate.

2. The electrical connector as described in claim 1, wherein the engaging portion defines a transitional portion located above the resilient contacting portion, and the transitional portion and the resilient contacting portion are at the same side relative to the main plate.

3. The electrical connector as claimed in claim 2, wherein the engaging portion defines an opening corresponding to the resilient contacting portion and the transitional portion.

4. The electrical connector as claimed in claim 3, wherein the insulative housing comprises a base and mating portion extending upwardly from the base, the base defines an upper face and a mounting face opposite to the upper face, the mating portion defines a plurality of receiving channels, said engaging portions of the terminals are received in the receiving channels, said mounting portions are positioned in the base and the tail portion extends beyond the mounting face.

5. The electrical connector as claimed in claim 4, wherein the base comprises a plurality of recesses and a plurality of T-shaped slots respectively communicating with the recesses.

6. The electrical connector as described in claim 5, wherein each recess defines a retaining slot, said mounting portion of the terminal retained in the retaining slot.

7. The electrical connector as described in claim 6, wherein the mounting portion of the terminal is of U-shape, and comprises a pair of parallel arms, at least the tail portion extends from the arm.

8. The electrical connector as claimed in claim 7, wherein the engaging portion of the terminal defines at least a locking portion below the resilient contacting portion and resisting against the upper face.

9. The electrical connector as claimed in claim 4, wherein the mating portion comprises a first receiving port and a pair of second receiving port alternatively space by the first receiving port, said first receiving port is columnar and said second receiving port is D-shaped.

10. The electrical connector as claimed in claim 9, wherein the first receiving port defines a columnar receiving channel and each second receiving port defines a D-shaped receiving channel.

11. An electrical connector for use with a complementary connector, comprising:
an insulative housing defining, along an insertion direction of said complementary connector, an elongated receiving cavity open to an exterior for allowing said complementary connector to be inserted along said insertion direction;
at least one contact disposed in the housing and including an elongated main body having a transitional portion extending from the main body, along said insertion direction, close to an exterior end of the receiving cavity, and a resilient contacting section extending from the main body behind the transitional portion in a direction opposite to said insertion direction; wherein
said transitional portion provides an rearward oblique guiding plane behind which said contacting section is protectively located.

12. The electrical connector as claimed in claim 11, wherein said transitional portion is not deflectable relative to the main body.

13. The electrical connector as claimed in claim 11, wherein said main body is deflectable with regard to the housing due to engagement between the complementary connector and the transitional portion.

14. The electrical connector as claimed in claim 11, wherein the transitional portion and said contacting section both extend away from the main body in a common lateral direction perpendicular to said insertion direction.

15. The electrical connector as claimed in claim 14, wherein said contact further includes a deflected free end extending in said lateral direction for protecting the transitional portion.

16. An electrical connector comprising:
an insulative housing defining three receiving cavities;
first, second and third contacts respectively disposed in the receiving cavities, each of said first, second and third contacts including respective contacting section located in the corresponding receiving cavity and a mounting section located outside of the corresponding receiving cavity; wherein
the contacting sections of both said first and second contacts extend in a first lateral direction while the contacting section of the third contact extend in a second lateral direction opposite to said first direction, and the mounting sections of both said first and third contacts extend in the second lateral direction while the mounting section of the second contact extends in a first lateral direction; whereby forces imposed upon the housing due to mating and mounting can be counterbalanced to be in a minimum amount.

17. The electrical connector as claimed in claim 16, wherein the mounting section defines a lying U-shaped configuration.

18. The electrical connector as claimed in claim 16, wherein solder tails of the mounting section extends in a direction along an insertion direction of the complementary connector.

19. The electrical connector as claimed in claim 17, wherein the mounting sections of both said second and third contacts cross centerlines of the corresponding receiving cavities while the mounting section of the first contact does not cross the centerline of the corresponding receiving cavity but being offset therefrom on one side thereof.
